(19) United States
(12) Patent Application Publication
(10) Pub. No.: US 2021/0302048 A1
(43) Pub. Date: Sep. 30, 2021

(54) ZONING DEVICES AND SYSTEM

(71) Applicant: Trolex Corporation, Randolph, NJ (US)

(72) Inventors: Richard Foster, Randolph, NJ (US); Tyler Hrycak, Randolph, NJ (US); Johan Andrade, Randolph, NJ (US); Majd Awad, Randolph, NJ (US)

(73) Assignee: Trolex Corporation, Randolph, NJ (US)

(21) Appl. No.: 17/212,386

(22) Filed: Mar. 25, 2021

Related U.S. Application Data
(60) Provisional application No. 62/994,498, filed on Mar. 25, 2020.

(51) Int. Cl. F24F 11/62; F24F 11/52; F24F 11/54; F24F 11/58; F24F 110/20; F24F 120/10; F24F 110/66

(52) U.S. Cl. CPC F24F 11/62; F24F 11/52; F24F 11/54; F24F 2110/66; F24F 2110/20; F24F 2120/10; F24F 11/58

(57) ABSTRACT

Disclosed is a wireless zoning system and devices for an HVAC system. Included is one or more light switch thermostat(s) designed to fit into a standard light switch box, a wireless zone control gateway, an HVAC control module, and one or more wireless damper sensors. The light switch thermostats include one or more mini pcb with a sensor mounted on it to monitor for example occupancy, humidity, and other VOC. The light switch thermostat also includes a vent opening on a switch plate located near the mini pcb with sensor. The wireless damper sensor is designed with RJ11 jacks to minimize cabling costs. The disclosed system can be designed for air or water HVAC systems.

### CROSS-REFERENCE TO RELATED APPLICATION

The present application claims priority to U.S. Provisional Patent Application Ser. No. 62/994,498 filed Mar. 25, 2020 which is hereby incorporated herein by reference in entirety for all purposes.

### BACKGROUND

When anyone is installing an HVAC zoning system in a house, or building they are faced with several challenges. One challenge is running thermostat wires to every zone. This can become cumbersome especially if the sheetrock and walls are already in place. One solution to this problem is the wireless radio frequency thermostat. The thermostat is a battery powered transmitter that sends signals wirelessly to a receiver unit that is connected to a zone control panel. This way the zone control panel can receive signals from the thermostat without the need to run wires to that zone. The thermostat requires very little power and is able to run off batteries.

As technology advances the demand for a modern smart home continues to increase. Many people demand to have their devices connected to the internet and controllable over their mobile devices. The major issue when connecting a device to the internet is the large power consumption. This means in many cases powering your device with batteries would not be an option. The resulting question is “How do you create a thermostat that can control an HVAC zoning system without the need to run wires directly to a zone control panel?” To solve this, we look to explore how traditional control devices around the home or building are powered and communicate. Typically, every room has a light switch that is supplied power and is easy to access. To eliminate the need to tradeoff between wireless or wifi we look to pull power from the light switch junction box to power a wireless thermostat. The power normally run to the light switch will be sufficient to enable a wifi communication and send wireless signals.

In order to power the wireless thermostat where an existing light switch used to be, the light switch must be removed. Disclosed are devices and system which incorporate the functionality of the light switch with the ability to power the wireless thermostat. Naturally, if wifi control is wired to the light switch it would make sense to have the ability to control both the light switch and the thermostat remotely over wifi via using other devices such as mobile devices.

### SUMMARY

Disclosed are devices and a system for controlling one or more HVAC zones utilizing one or more of each of the following: Light Switch Thermostat/Wireless Zone Controller, Wireless Damper Sensor, HVAC Control Module, and Zone Control Gateway. The HVAC system including dampers or valves are controlled by one or more Wireless Damper Sensors. For HVAC systems using piping valves are controlled by a Wireless Valve Sensor. An HVAC Control Module receives commands from the Light Switch Thermostat and sends signals to the Wireless Damper Sensor and HVAC equipment as warranted. The Light Switch Thermostat includes a touch screen to enable programming the HVAC Control Module. The Light Switch Thermostat also includes one or more environment/VOC sensors as desired.

The disclosed wireless zoning system can be configured to control for water or air HVAC systems, as well as for electric/gas HVAC equipment or heat pumps. The disclosed wireless zoning system is capable of controlling multiple speed fans/blowers. The disclosed wireless zoning system can also be programmed to control humification and dehumidification equipment.

For multiple stage HVAC equipment, the disclosed is programmed to provide stage timing and delays as needed.

### BRIEF DESCRIPTION OF DRAWINGS

FIG. 1 depicts front and side views of the internals for the Light Switch Thermostat.

FIG. 2 depicts a front view of the front view of the Light Switch Thermostat.

FIG. 3 depicts a view of one screen for the Light Switch Thermostat.

FIG. 4 depicts one embodiment of views of the changing screens of the Light Switch Thermostat as the device is being programmed.

FIG. 5 depicts a bottom front left view of the Light Switch Thermostat.

FIG. 6 depicts a bottom front left view of the switch plate with the Light Switch Thermostat.

FIG. 7 depicts a front, side and top views of the Light Switch Thermostat.

FIG. 8 depicts a rear view of the HVAC Control Module.

FIG. 9 depicts a rear left view of the HVAC Control Module.

FIG. 10 depicts a front view of the Wireless Damper Sensor.

FIG. 11 depicts a front left view of the Wireless Damper Sensor.

FIG. 12 depicts a front right view of the Wireless Damper Sensor.

FIG. 13 depicts a rear view of the Wireless Damper Sensor.

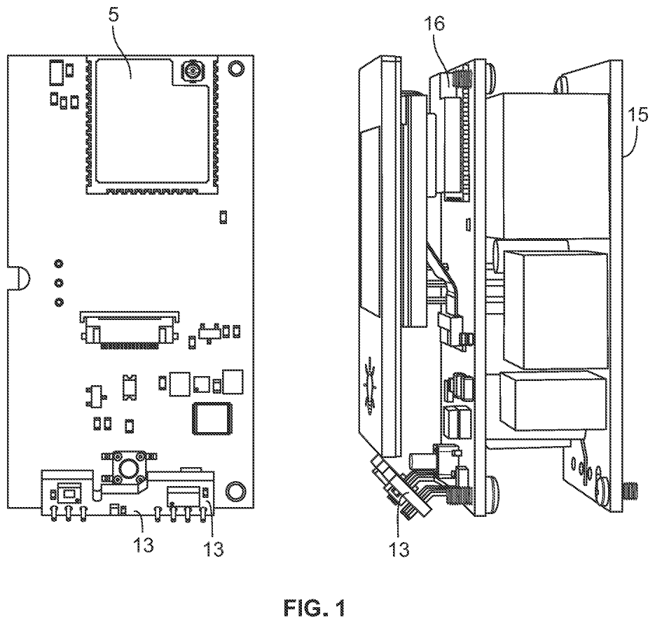

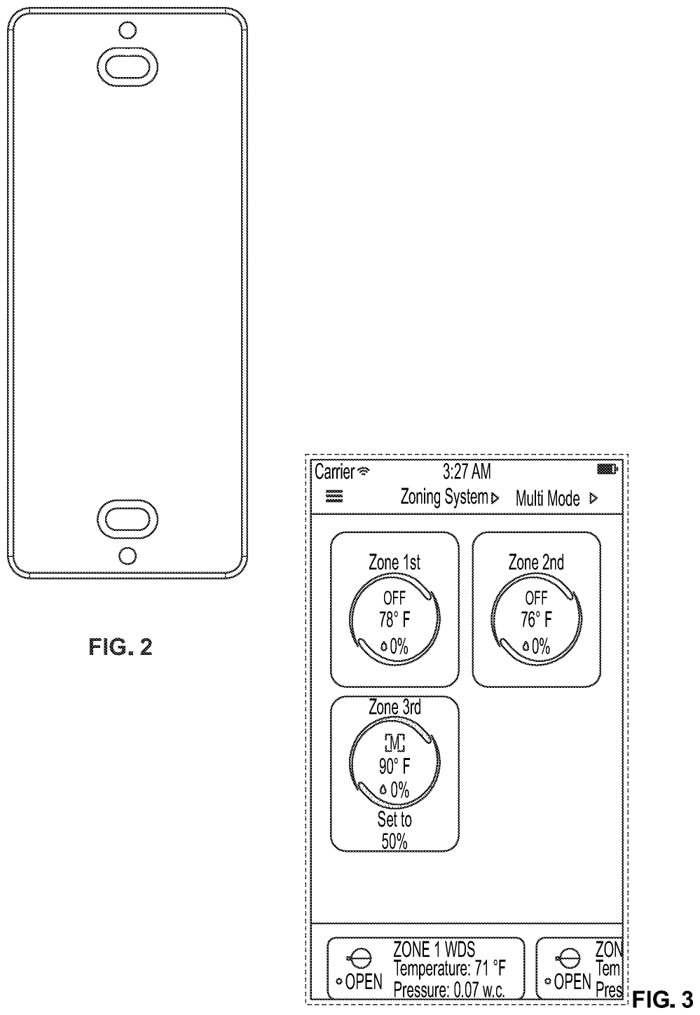

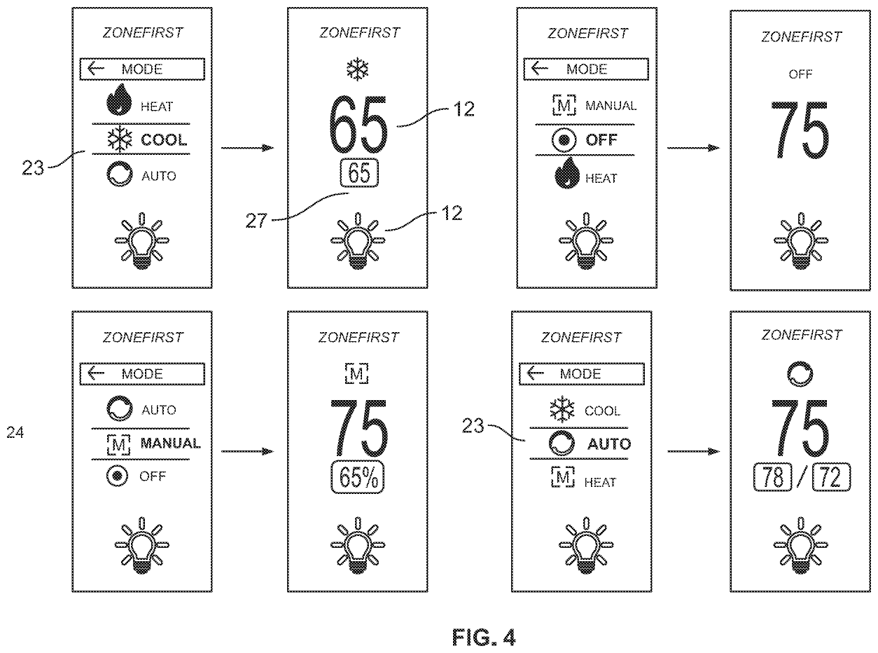

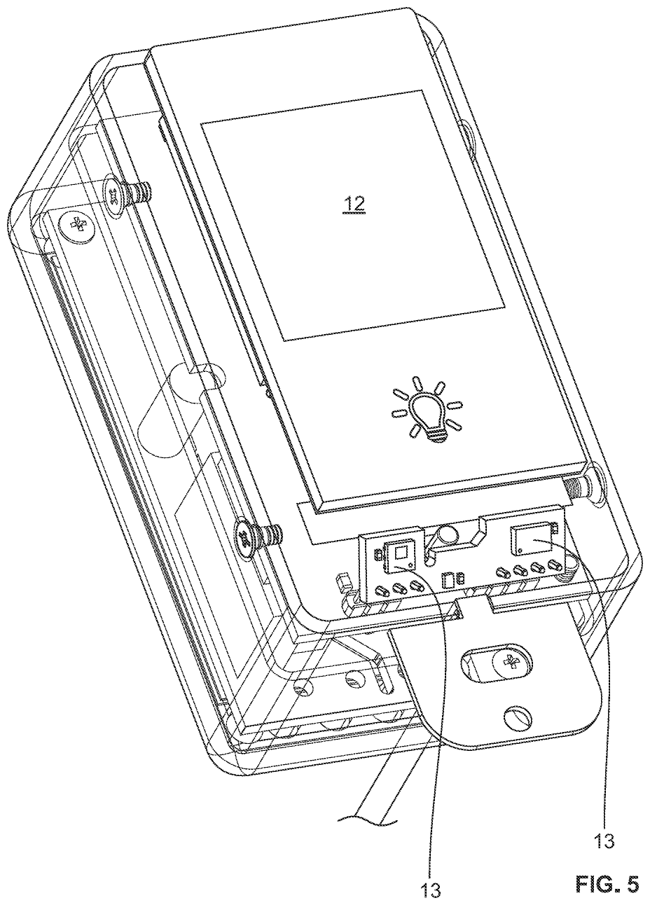

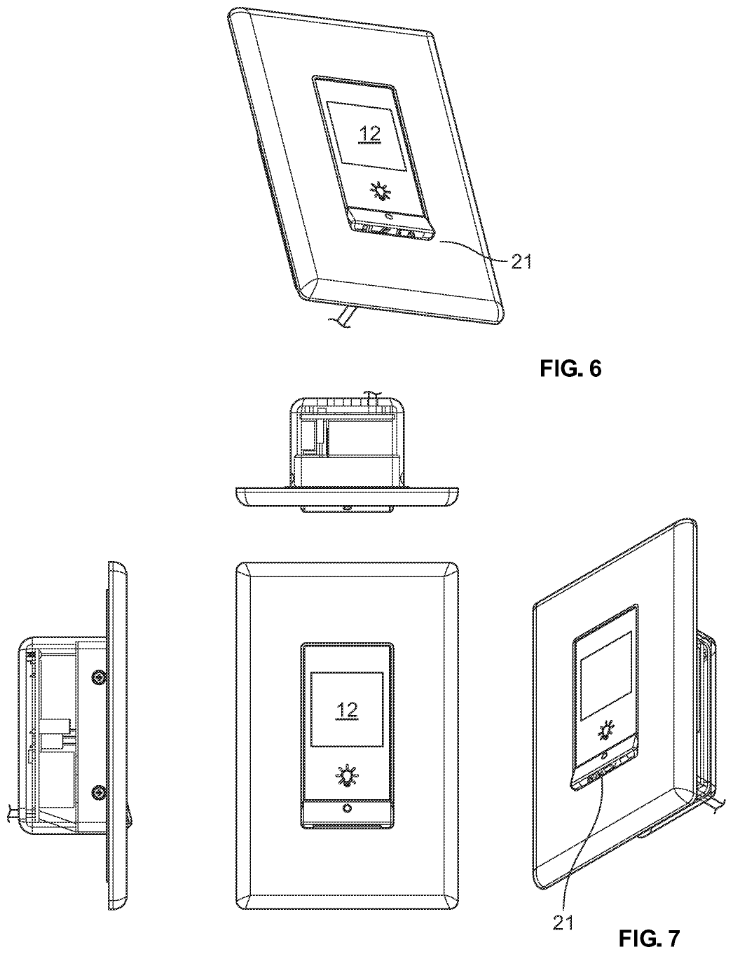

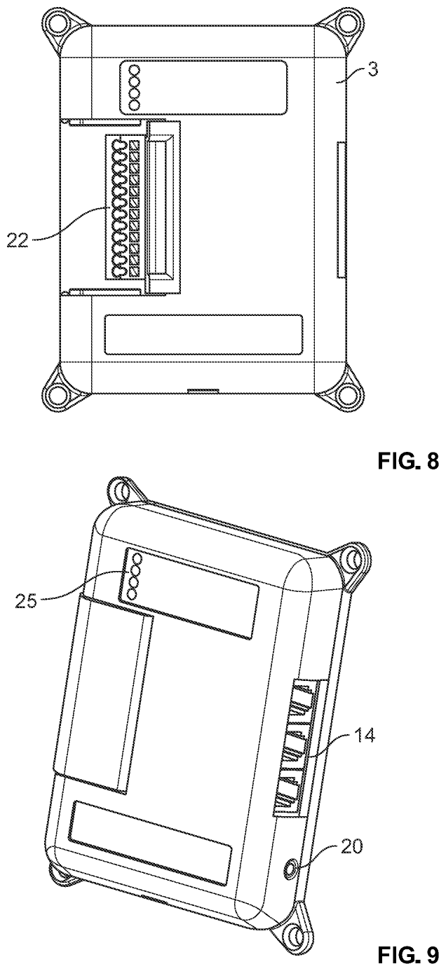

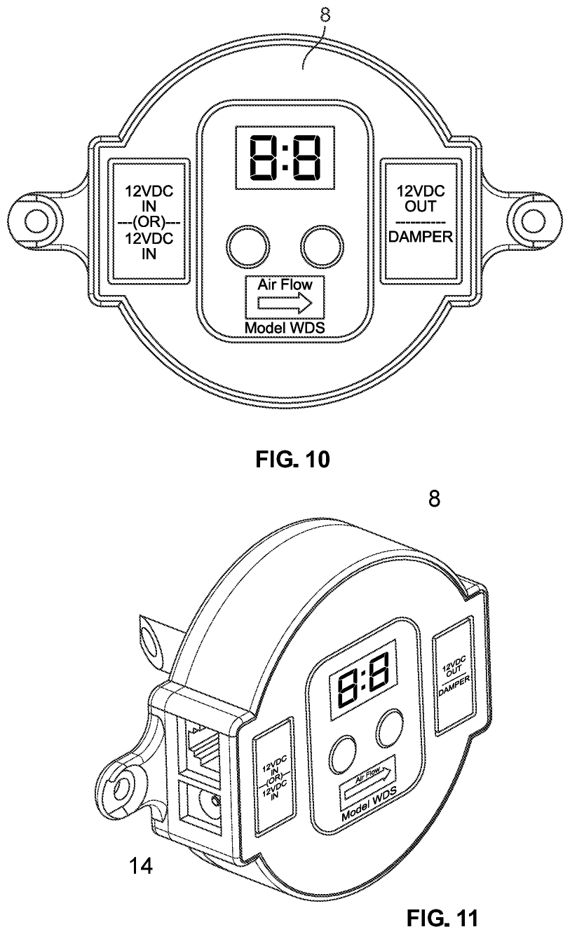

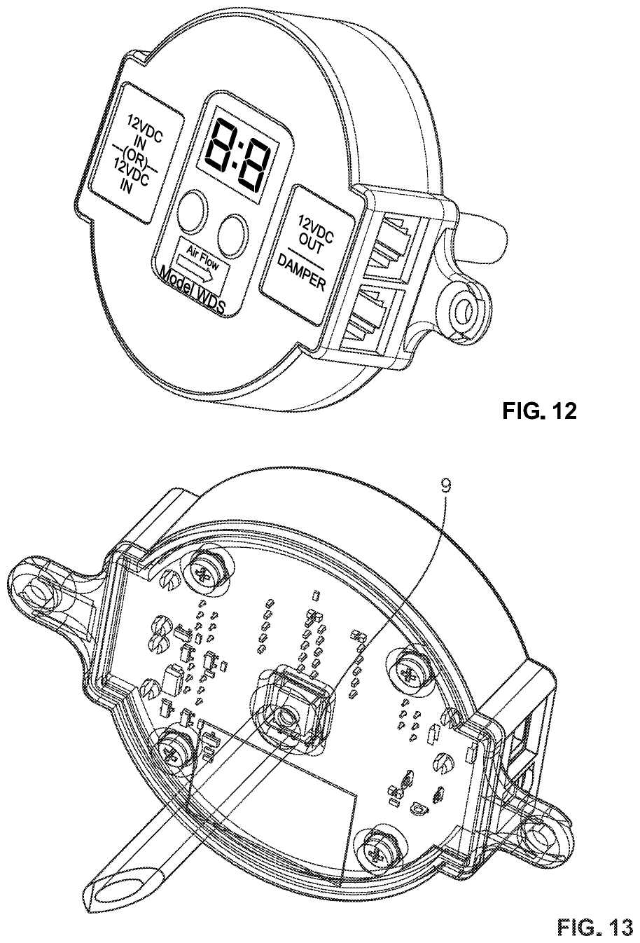

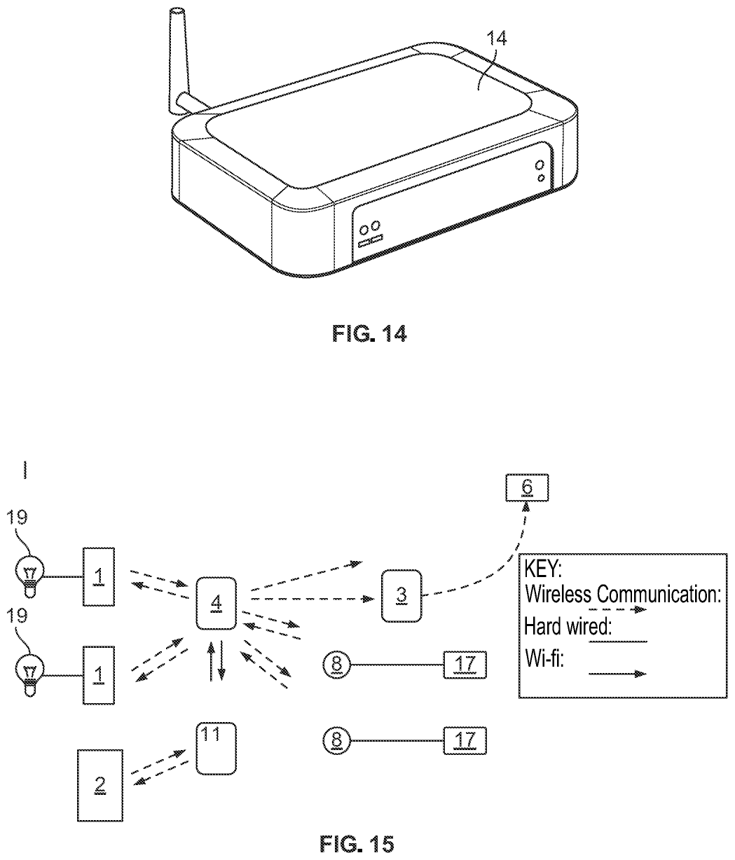

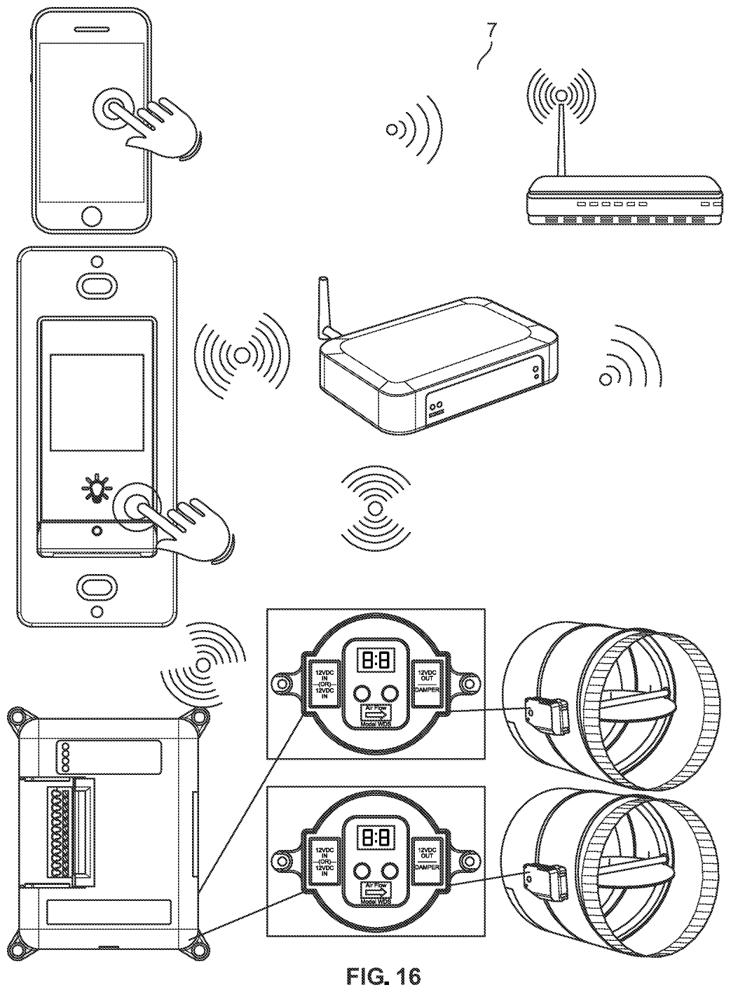

FIG. 12 depicts a front view of the Zone Control Gateway.

FIG. 15 is a diagram of the wireless zoning system for one embodiment.

FIG. 16 depicts the devices and interconnections of the wireless zoning system.

### PART NUMBERS

1—Light Switch Thermostat (LST)/Wireless Zone Controller (WZC)
2—User device e.g. pc/laptop, mobile device
3—HVAC Control Module (HCM)
4—Zone Control Gateway (ZCG)
5—WiFi Module
6—HVAC equipment
7—Wireless Zoning System (WZS)
8—Wireless Damper Sensor (WDS)
9—Pressure sensor
10—Damper
11—Router
12—Touch screen
13—Sensors mounted on min pcb boards
14—RJ11 telephone cord jack
15—Power pcb board
16—Control pcb board
17—Damper motor
18—Pressure sensor
19—Light
20—HVAC Control Module reset button
21—Ventilation opening
22—HVAC Control Module wiring terminals
23—Display mode icon
24—Switch plate
25—LED
26—
27—Temperature display setup screen

### DETAILED DESCRIPTION

The disclosed Zoning Devices and System is controlled by a Light Switch Thermostat (LST) (1) which is also referred to as a Wireless Zone Controller (WZC) (1). Combining a thermostat into a light switch form factor presents several functional and aesthetic benefits. Putting these two functionalities together (light and temperature control) into one device simplifies the user experience and gives the user control from at the LST or remote control for example using a mobile device (2). Using a zigbee wireless protocol, the device can communicate with an HVAC Control Module (HCM) (3) to control the HVAC equipment (6). In addition, the device can be designed to communicate with a Zone Control Gateway (ZCG) (4) as an access point to the internet. A wi-fi module (5) is also built into the device directly in order to remove the need for the ZCG (4) when set up for a single zone system. The LST (1) device can be set up as a single thermostat or be a part of a Wireless Zoning System (WZS) (7) which controls dampers/valves to direct and isolate airflow/water flow in an HVAC system.

As mentioned previously, these devices can be integrated with an entire wireless zoning system (7 on FIG. 16). The wireless zoning system (7) includes light switch thermostat (LST) (1) a wireless damper sensor (WDS) (8), an HVAC control module (HCM) (3), and a zone control gateway (ZCG) (4). The WDS (8) contains a pressure sensor (9) to allow a zone damper to act as a bypass. The WDS gets mounted directly on the duct work, or on the damper itself (10). The appropriate power source is provided to the WDS. All communication is carried using a wireless protocol. This allows the damper (10) to respond to remote inputs from the user, or inputs from other nodes in the system. A system/process diagram is shown on FIG. 15).

In one embodiment, the touch screen display (12) would show both light and thermostat controls. The screens would be dynamic and change based on the users touch input. Several sensors will be placed internally to allow the device to read temperature, humidity, VOC's, carbon monoxide, carbon dioxide, and smoke (13) as chosen by the user. These sensors will allow the device to function as a thermostat, air purity sensor, smoke alarm, and light switch. Combining all these functions dramatically reduces the footprint of devices and cost associated. In addition, when the device is paired with a fresh air cycler it can bring fresh air into a room and remove tainted air. This can increase safety, cleanliness and productivity inside a residence or building.

In one embodiment, the LST (1) device would be wired directly to the 120 vac line voltage; much like a typical light switch would be wired. The screen would fit into a standard decora light switch plate (24). In one embodiment the LST (1) device would contain 3 printed circuit boards (pcb's). One pcb would be a power pcb board (15), with a relay or triac; another would be a control pcb board (16) with two microcontrollers, one Wi-Fi module, and one zigbee module. This printed circuit board (pcb) may also have an LED (25) to indicate whether the light (19) is turned on or off. A third mini pcb would have a sensor (13) mounted on it. Multiple mini pcb with sensor can be included.

### LST (Light Switch Thermostat)/WZC (Wireless Zone Controller)

The LST (1) is a wireless thermostat with light control and a capacitive touch user interface. It utilizes front mounted sensors to sense temperature, humidity, and CO2 and other VOCs (13). The light switch icon can be pressed to turn on and off the light it is wired to (19). The wireless zoning system (WZS) can also be fully controlled remotely utilizing a user device (2) such as with a pc, tablet, or mobile device (2) app wirelessly connected to a router (11).

The LST includes multi-sensor (13) integration via mini pcb into a light switch form factor. Separating these sensors mounted on mini pcb's allows for increased heat dissipation, leading to more accurate sensor readings. This also allows for easier customization of sensor integrations from a manufacturing standpoint.

The LST (1) also includes a curved slot opening (21) for sensors (13) This curved slot opening slightly extends past the switch plate (24) to get proper ventilation/air flow to and provide accurate sensor readings.

Most existing products leverage an external smart thermostat to control the equipment and do not have room to room sensing. By adding sensors into each and every LST and having a separate control module we are able to commutate over a secure local network without having to tap into the smart thermostats back-end APIs. This creates a reliable and robust wireless system. Wi-Fi is utilized to control the system via commands from the LST or remote devices.

The Zoning Devices and System disclosed is designed with a user interface design which is basic but intuitive. It is designed to be user friendly, simple, and easy to use. To change modes the user will push the displayed mode icon (23), to take them to the mode select screen (24). The user will swipe up, or down to drag the desired mode to the middle screen selection, and then tap the selected mode, to return back to the man screen (26). To change the set point, the user will click the lower displayed number button (27). The following mode options are available: Heat, Cool, Manual, Auto, Fan, or Off. When in Heat mode the LST will send a signal to the HCM to turn the HVAC equipment (6) on when the set point is above the room temperature sensor reading. When in Cool mode the LST will send a signal to the HCM to turn the HVAC equipment (6) on when the set point is below the room temperature sensor reading.

When in Auto mode the user will be able to adjust two set points. An upper and lower set point. When in Auto mode the LST (1) will send a signal to the HCM (3) to turn the HVAC cooling unit on when the set point is below the room temperature sensor reading, or it will send a signal to signal to the HCM to turn the HVAC heating unit on when the set point is above the room temperature sensor reading. When in manual mode the LST will send a signal to the corresponding WDS (8) for that particular zone to adjust the damper position to the set point (e.g. 25%). This damper position will be maintained in the correct position regardless of room sensor reading. For fan mode the LST sends a signal to the HCM to turn on the fan. If any other zones are calling for more than fan operation, the fan will hold the lowest priority. If off mode is selected that LST (1) will not send any signals to the HCM (3) and the HVAC equipment (6) will be turned off. In one embodiment the user can adjust the screen brightness and turn on emergency heat utilizing a side drop down menu on the LST.

### HCM (HVAC Control Module)

The HCM (3) controls the HVAC equipment as directed by the ZCG (4). In one embodiment the HCM (3) features 4 indicator LED's (25) to show Power, Mode, Hum, and DeHum. In this embodiment the led indications are as follows:
Power: solid green power on
Mode: Red call for heat; Blue call for cool; Yellow call for fan; Blinking green—not connected to Zone Control Gateway
Hum red call for humidity;
Dehum purple call for dehumidify

The case features a pop-up door to allow for easy wiring. The HCM (3) can be powered by a 12 vdc power supply. It uses triacs to energize the HVAC equipment (6) when receiving a status call. Three RJ11 jacks (14) are provided to power the WDS (8) sensor and zone dampers. There is also a reset button (20).

In one embodiment the HCM includes the following:
1 pcb
microcontroller
zigbee communication Capability
12 VDC Power Connection
RJ11 jacks
terminal block
triacs

### WDS (Wireless Damper Sensor)

The WDS (8) controls and powers the associated zone damper as directed by the Zone Control Gateway ZCG (4) The WDS (8) has a built-in pressure/temp sensor that gets inserted into the ductwork before the zone damper. This pressure sensor eliminates the need for a bypass damper and allows for zone by zone bypass control. Using the buttons and segment LED display the installer can assign a zone number to each WDS (8). The WDS (8) can also be used to control a fresh air damper that brings in outdoor air.

The WDS (8) is designed to allows for zone configuring, pressure/temp readings and damper control using RJ11 telephone cords which minimizes cost of installation.

Integration of an air sampling tube that senses temperature and pressure directly on the WDS (8) provides the ability to have a local feedback loop to each individual damper to bypass excess airflow, instead of traditionally having one sensor bypass the whole system. This increases efficiency and accuracy. The sensor also gives us much more insights about the system health in regard to temperature and pressure, allowing integration logic to self-balance the system, and reduce predictive maintenance. This also overcomes the problem of incorrectly sized units and ductwork. In one embodiment the WDS (8) includes the following:
pcb
microcontroller
zigbee communication Capability
12 VDC Power Connection
Rill Jacks
push button interface
segment LED's
pressure/temp Sensor

### ZCG (Zone Control Gateway)

The ZCG (4) is the brains of the system and communicates with the LST (1), HCM (3), and WDS (8). This is where all the business logic is built in. The ZCG (4) also acts as the access point to Wi-Fi via a router 11). This allows the system to be controlled remotely via multiple devices such as a mobile device.

In one embodiment the ZCG (4) is a standard hub including the following:
pcb
microcontroller
Wifi communication capability
zigbee communication capability
ethernet connection
DC power connection
USB port
external antenna
Disclosed are wireless zoning devices and system comprising:
   a zone control gateway including: an enclosure, a minimum of one pcb, a minimum of one microcontroller, a Wifi communication capability, a zigbee communication capability, an ethernet connection, a power connection, a USB port, and an external antenna, wherein the zone control gateway communicates with at least one light switch thermostat, at least one HVAC control module, and at least one wireless damper sensor;
   the light switch thermostat including: an enclosure, a light switch, a touch screen, a temperature sensor, a minimum of one pcb as a power pcb board, a minimum of one control pcb board with at least one microcomputer, at least one additional mini pcb connected to a sensor, a minimum of one triac, a wifi module, a zigbee module, at least one led light, a and a vent opening in a switch plate for the light switch thermostat, wherein the light switch thermostat provides directions to the zone control gateway;
   the HVAC control module including: an enclosure, at least one pcb, at least one microcontroller, a triac, a zigbee communication capability, a power connection, at least one RJ11 jack, and a terminal block, wherein the HVAC control module communicates directions to an HVAC equipment; and
   the wireless damper sensor connected to a damper including, an enclosure, a pcb, a microcontroller, a zigbee communication capability, a power connection, a minimum of one RJ11 jack, a push button interface, a minimum of one segment LED, and a pressure/temperature sensor.

Other embodiments disclosed include one or more of the following:
the light switch thermostat includes at least two mini pcb with each connected to a sensor; the sensor for each of the least two additional mini pcb are chosen from occupancy sensor, humidity sensor, VOC sensor.
the touch screen allows a selection of a mode from a minimum of: on, off, heat, cool, fan manual, and fan auto;
the light switch thermostat further allows two setpoints to be selected for the temperature and an ability to set temperatures a minimum of two times each day;
the zone control gateway is able to receive commands from a wireless user device;
the light switch thermostat includes a switch plate on its front with an opening near all mini pcb connected to a sensor;
the wireless damper sensor further includes a pressure sensor;
the light switch thermostat further includes a drop down menu on the screen to adjust brightness;
the HVAC control module further comprises a minimum of 4 LED's indicating a status of power, mode, humidity control, and dehumidity control.

Having described preferred embodiments which serve to illustrate various concepts, structures and techniques which are the subject of this patent, it will now become apparent to those of ordinary skill in the art that other embodiments incorporating these concepts, structures and techniques may be used. For example, as mentioned the wireless zoning system can be utilized for air or water HVAC systems. Accordingly, it is submitted that that scope of the patent should not be limited to the described embodiments but rather should be limited only by the spirit and scope of the following claims.

We claim:

1. A wireless zoning system comprising:
a zone control gateway comprising: an enclosure, a minimum of one pcb, a minimum of one microcontroller, a Wifi communication capability, a zigbee communication capability, an ethernet connection, a power connection, a USB port, and an external antenna, wherein the zone control gateway communicates with at least one light switch thermostat, with at least one HVAC control module, and with at least one wireless damper sensor;
the at least one light switch thermostat comprising: an enclosure, a light switch, a touch screen, a temperature sensor, a minimum of one power pcb board, a minimum of one control pcb board with at least one microcomputer, at least one mini pcb connected to a sensor, a minimum of one triac, a wifi module, a zigbee module, at least one led light, and a vent opening in a switch plate for the at least one light switch thermostat, wherein the at least one light switch thermostat provides directions to the zone control gateway;
the at least one HVAC control module comprising: an enclosure, at least one pcb, at least one microcontroller, a triac, a zigbee communication capability, a power connection, at least one RJ11 jack, and a terminal block, wherein the HVAC control module communicates directions to an HVAC equipment; and
the at least one wireless damper sensor connected to a damper comprising, an enclosure, a pcb, a microcontroller, a zigbee communication capability, a power connection, a minimum of one RJ11 jack, a push button interface, a minimum of one segment LED, and a pressure/temperature sensor.

2. The wireless zoning system according to claim 1 wherein the at least one light switch thermostat comprises at least two additional mini pcb with each connected to a sensor.

3. The wireless zoning system according to claim 2 wherein the sensor for each of the least two additional mini pcb are chosen from occupancy sensor, humidity sensor, VOC sensor.

4. The wireless zoning system according to claim 1 wherein the touch screen allows a selection of a mode from a minimum of: on, off, heat, cool, fan manual, and fan auto.

5. The wireless zoning system according to claim 1 wherein the at least one light switch thermostat further allows two setpoints to be selected for a temperature and an ability to set the temperature a minimum of two times each day.

6. The wireless zoning system according to claim 1 wherein the zone control gateway is able to receive commands from a wireless user device.

7. The wireless zoning system according to claim 1 wherein the at least one light switch thermostat includes a switch plate on its front with an opening near the at least one mini pcb connected to a sensor.

8. The wireless zoning system according to claim 1 wherein the wireless damper sensor further comprises a pressure sensor.

9. The wireless zoning system according to claim 1 wherein the at least one light switch thermostat further comprises a drop down menu on the screen to adjust brightness.

10. The wireless zoning system according to claim 1 wherein the at least one HVAC control module further comprises a minimum of 4 LED's indicating a status of power, mode, humidity control, and dehumidity control.
